(19) United States
(12) Patent Application Publication
(10) Pub. No.: US 2022/0344085 A1
(43) Pub. Date: Oct. 27, 2022

(54) METHOD FOR HEAT TREATING AT LEAST ONE SHEET MADE OF A SOFT MAGNETIC ALLOY

(71) Applicant: Vacuumschmelze GmbH & Co KG, Hanau (DE)

(72) Inventors: Niklas Volbers, Hanau (DE); Johannes Tenbrink, Hanau (DE); Marcus Gerke, Hanau (DE)

(21) Appl. No.: 17/702,871

(22) Filed: Mar. 24, 2022

(30) Foreign Application Priority Data
Apr. 14, 2021 (DE) 102021109326.0

(51) Int. Cl. H01F 1/153; H01F 1/147

(52) U.S. Cl. CPC H01F 1/15308; H01F 1/14716

(57) ABSTRACT

A method for the heat treatment of at least one sheet made of a soft magnetic alloy is provided. At least one sheet made of a soft magnetic alloy is heat treated at a temperature of between 400° C. and 1300° C. for a period of at least 15 minutes in a hydrogen-containing atmosphere. During this heat treatment the gas pressure level of the hydrogen-containing atmosphere is changed at least twice.

This U.S. patent application claims priority to DE Patent Application No. 10 2021 109 326.0, filed Apr. 14, 2021, the entire contents of which is incorporated herein by reference in its entirety.

### BACKGROUND

### 1. Technical Field

The invention relates to a method for the heat treatment of at least one sheet made of a soft magnetic alloy, in particular for the final annealing of an FeCo-based alloy.

### 2. Related Art

EP 3 730 286 A1 discloses a method in which a plurality of parts or individual sheets is placed in a stack and annealed in this stack in order to ensure their flatness. Depending on the application, this stack may also be weighted down with a covering plate. This annealing set-up results in flat sheets and also permits the annealing of very large numbers of sheets. The prerequisite for this is that the sheets also be separated from one another by an annealing separator, for example by insulating the sheets or the preliminary material used to make the sheets with an annealing-resistant ceramic coating. This ensures that the individual sheets do not fuse together at the high annealing temperatures.

To achieve the desired effect hydrogen flushing should be as even as possible and take place over the entire surface, even when parts are large and the furnace fill level very high. One possible way of achieving even hydrogen rinsing is to anneal the parts hanging, e.g. by stringing them on rods. However, this annealing set-up is not possible in all cases. It may result in warping at very high temperatures since the sheets have a greatly reduced yield limit during annealing and may warp as a result of their self-weight. In addition, positioning and separating the parts involves very significant levels of effort and therefore increased costs.

An object is therefore to provide a method for the final annealing of a soft magnetic alloy by means of which good magnetic properties can be achieved reliably for relatively large parts and high furnace fill levels.

### SUMMARY

According to the invention, a method is provided in which at least one sheet made of a soft magnetic alloy is heat treated at a temperature of between 400° C. and 1300° C. for a period of at least 15 minutes in a hydrogen-containing atmosphere, whereby during this heat treatment the gas pressure level of the hydrogen-containing atmosphere is changed at least twice. For example, during this heat treatment the gas pressure level of the hydrogen-containing atmosphere is changed at least twice an hour, preferably at least five times.

Herein the term “gas pressure level” indicates the static pressure of the annealing atmosphere in the furnace chamber.

This heat treatment is carried out after the mechanical steps such as hot rolling and cold rolling used to produce the strip from which the sheet or sheets are formed and is also referred to as final annealing. The sheet is therefore at its final thickness. The sheet may have an outer contour that corresponds to the outer contour of an individual sheet of a laminated core, for example an E-shape or a ring shape or a ring shape with teeth, as used for rotor or stator laminations, for example. Alternatively, the sheet may have an elongated form such as a strip, or a square or rectangular shape, for example, from which a sheet with the outer contour for a laminated core can subsequently be formed.

When annealing soft magnetic alloys in hydrogen an improved cleaning action is ensured by means of controlled pressure fluctuations. The pressure can be switched repeatedly back and forth between two predetermined levels. The two pressure levels are both typically overpressures and thus higher than the ambient pressure. In principle, however, pressure levels ranging from close to a vacuum, e.g. 1 mbar, to 200 bar can be used. In further embodiments the pressure is switched between more than three different predetermined levels at least twice or more than twice. It is thus possible to achieve good, uniform magnetic properties reliably when hydrogen rinsing relatively large parts at high furnace fill levels. In particular, the invention provides a method and device for the final annealing of sheets or laminated cores that provides effective gas exchange also between the sheets during final annealing as the final annealing is carried out under pulsating hydrogen pressure.

In an embodiment, during the heat treatment the gas pressure level is switched between a first predetermined gas pressure level G1 and a second predetermined gas pressure level G2, the gas pressure levels G1 and G2 being between 1 mbar and 200 bar, and the difference |G1-G2| being between 1 mbar and 200 bar. In an embodiment, the difference |G1-G2| is between 10 mbar and 1 bar, preferably between 50 mbar and 1 bar at least twice

In an embodiment, the gas pressure level is changed at least five times per hour during the heat treatment.

In an embodiment, a plurality of sheets is stacked one on top of another to form a stack, and the stack is heat treated.

In an embodiment, the stack is weighted down with an additional weight, and the stack is heat treated with the weight heat. The weight weighs at least 20%, preferably at least 50%, of the weight of the preliminary product.

In an embodiment, the sheet or sheets also have an electrical insulating layer that has a thickness of 0.1 μm to 10 μm, preferably 0.1 μm to 5 μm, preferably 0.1 μm to 2 μm.

In an embodiment, the sheet or sheets have a thickness of 0.05 mm to 1 mm, preferably 0.05 mm to 0.50 mm.

In an embodiment, the heat treatment is carried out stationarily in a furnace.

In an embodiment, the gas pressure is changed by activating an air lock function of the furnace by conveying the material to be annealed from one chamber with a gas pressure level G1 into a chamber with a gas pressure level G2 via a suitable airlock, also referred herein as a gas lock.

In an embodiment, the heat treatment is carried out in a single-chamber furnace (stationary, opened and closed at ambient pressure). It is possible to set a treatment temperature and different pressure levels (two or more) for a treatment period. It is possible to run a plurality of treatment periods with different temperatures and pressure levels one after another. The gas pressure level is changed several times during the treatment period.

In an embodiment, the heat treatment is carried out in a dual- or multi-chamber furnace with a lock function between chambers. Here, the second treatment period is achieved by transferring the material to be annealed to a second chamber. This transfer requires the pressure in the two chambers to be equal. Alternatively, a pressure lock can be used. With dual- or multiple-chamber furnaces and a lock function it is also possible to vary the protective gas used in each chamber.

In an embodiment, the heat treatment is carried out in an extended continuous furnace with pulsating pressure levels G1, G2, G3, etc. but at different temperatures, with pressure locks at the entry and exit. The temperature at the material to be annealed is set by moving the annealing material through the different temperature zones of the furnace. In contrast, the changing pressure levels (static pressure) in the various temperature zones of the continuous furnace are the same. This requires an entry lock and an exit lock (airlock or gas lock) for the material to be annealed.

In an embodiment, the sheet or sheets are made of an FeCo alloy or a NiFe alloy or an Fe-based alloy.

In an embodiment, the sheet or sheets has/have a composition consisting essentially of:

| | | |
|---|---|---|
| 2 wt % | ≤Co | ≤30 wt % |
| 0.3 wt % | ≤V | ≤5.0 wt % |
| 0 wt % | ≤Cr | ≤3.0 wt % |
| 0 wt % | ≤Si | ≤5.0 wt % |
| 0 wt % | ≤Mn | ≤5.0 wt % |
| 0 wt % | ≤Al | ≤3.0 wt % |
| 0 wt % | ≤Ta | ≤0.5 wt % |
| 0 wt % | ≤Ni | ≤1.0 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

the rest iron and up to 0.2 wt % of other impurities due to melting, the sheet or sheets having a phase transition from a BCC-phase region to a mixed BCC/FCC region to an FCC-phase region, as the temperature increases the phase transition between the BCC-phase region and the mixed BCC/FCC region taking place at a first transition temperature T_{α/α+γ} and as the temperature increases further the transition between the mixed BCC/FCC region and the FCC-phase region taking place at a second transition temperature T_{α+γ/γ}.

In an embodiment, in order to produce the sheet, a strip is first provided, and this strip is then partially coated with a ceramic-forming layer, whereby 20% to 80% of the total surface of the preliminary product remains free of the ceramic-forming layer and the sheet or sheets are formed from the strip and the partially coated sheet or partially coated sheets heat treated.

In an embodiment, the sheet or sheets are partially coated with a ceramic-forming layer, whereby 20% to 80% of the total surface of the preliminary product remains free of the ceramic-forming layer and the partially coated sheet or the partially coated sheets are treated.

In some embodiments, the two opposing sides of the strip or sheet or sheets are partially coated such that 20% to 80% of each opposing side of the strip or sheet or sheets remain free of the ceramic forming layer.

In an embodiment the heat treatment comprises:
heating up the preliminary product, and then
heat treating the preliminary product in a first stage for a total time t₁, in the first stage the preliminary product being heat treated at a temperature within a temperature range of between T_{α+γ/γ} and T₁, and the
cooling the preliminary product to room temperature.

The heat treatment is carried out for at least part of the time in a hydrogen-containing atmosphere and during this time the exposed parts of the surface of the preliminary product are in direct contact with the hydrogen-containing atmosphere, where T₁>T₂, T₁ is above T_{α+γ/γ} and T₂ is below T_{α/α+γ}.

In an embodiment the heat treatment comprises:
heating up the preliminary product, and then
heat treating the preliminary product in a first stage for a total time t₁, in the first stage the preliminary product being heat treated at a temperature within a temperature range of between T_{α+γ/γ} and T₁, and then
cooling the preliminary product to a temperature T₂, and then
heat treating the preliminary product in a second stage at temperature T₂ for a time t₂, and then
cooling the preliminary product to room temperature.

The heat treatment is carried out for at least part of the time in a hydrogen-containing atmosphere and during this time the exposed parts of the surface of the preliminary product are in direct contact with the hydrogen-containing atmosphere, where T₁>T₂, T₁ is above T_{α+γ/γ} and T₂ is below T_{α/α+γ}.

In an embodiment, T_{α+γ/γ}<T_{α/α+γ} and the difference T_{α+γ/γ}−T_{α/α+γ} is less than 45K, preferably less than 25K.

In an embodiment, after the heat treatment the sheet or sheets have a fraction or area proportion of a {111}<uvw> texture of no more than 13%, preferably no more than 6%, including grains with a tilt of up to +/−10° preferably up to +/−15° when compared with the nominal crystalographicl orientation.

In an embodiment, after the heat treatment the sheet or sheets have a area proportion of a {100}<uvw> cube-face texture of at least 30%, preferably at least 50%, including grains with a tilt of up to +/−15° or preferably up to +/−10° when compared with the nominal crystallographic orientation.

In an embodiment, in order to produce the sheet or sheets the method also comprises providing a melt using vacuum induction melting, electro-slag remelting or vacuum arc remelting, the melt consisting essentially of:

| | | |
|---|---|---|
| 2 wt % | ≤Co | ≤30 wt % |
| 0.3 wt % | ≤V | ≤5.0 wt % |
| 0 wt % | ≤Cr | ≤3.0 wt % |
| 0 wt % | ≤Si | ≤5.0 wt % |
| 0 wt % | ≤Mn | ≤5.0 wt % |
| 0 wt % | ≤Al | ≤3.0 wt % |
| 0 wt % | ≤Ta | ≤0.5 wt % |
| 0 wt % | ≤Ni | ≤1.0 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

the rest iron and up to 0.2 wt % of other impurities due to melting.

The melt is solidified to form an ingot, the ingot is mechanically deformed to produce a strip and the sheet or sheets are formed from the strip.

In an embodiment, the mechanically deformed is carried out by means of hot rolling and/or forging and/or cold forming, the ingot being mechanically defomred by means of hot rolling at temperatures of between 900° C. and 1300° C. to form a slab, then to form a hot strip of thickness D₁ and then being reformed by cold rolling to form a strip of thickness D₂, where 0.05 mm≤D₂23 1.0≤mm and D₂<D1.

In an embodiment, the hot strip of thickness D₁ is first produced by continuous casting and then mechanically deforemd by means of cold rolling to form the strip of thickness D₂, whereby 0.05 mm≤D₂≤1.0 mm, preferably 0.05 mm≤D₂≤0.50 mm, and D₂<D₁, the degree of cold deformation by cold rolling being >40%, preferably >80%, preferably >95%.

### BRIEF DESCRIPTION OF THE DRAWINGS

Embodiments are explained in greater detail below with reference to the drawings and the following examples.

FIG. 1 shows a schematic illustration of the effect of insufficient hydrogen sheet rinsing due to the annealing of the sheets in a sheet stack according to a comparative example.

FIG. 2 shows a simplified illustration of the annealing of sheets in a stack.

FIG. 3 shows the dimensions of the stack of sheets and the formula symbols used by reference to a plate heat exchanger, in the case of a sheet stack considered in this application H═H_{f}, i.e. plates only, no base.

FIG. 4 shows a graph of gas exchange per hour by way of example.

### DETAILED DESCRIPTION OF EXAMPLE EMBODIMENTS

A soft magnetic alloy is provided in the form of at least one sheet. The soft magnetic alloy may be an FeCo alloy or a NiFe alloy or an Fe-based alloy. The sheets may each have a thickness of 0.05 mm to 1.0 mm and a length and width of at least 5 mm to approx. 1 m. The sheets may, in particular, be shaped like rotor or stator laminations of electric motors or generators, for example. Following final forming, the sheet or sheets are subject to final annealing in a reducing atmosphere in order to achieve improved soft magnetic properties. In addition to recrystallisation and grain growth, this also produces a pruification action in relation to non-metallic impurities such as carbon, sulphur, nitrogen and oxygen.

Typically, a plurality of sheets is subjected to final annealing at the same time, the sheets being stacked, and the stack being subjected to final annealing. In practice, however, a set-up of this type in which the sheets are in close contact with one another, results in disadvantages with regard to flushing, i.e. it hampers the even flushing of the entire sheet surface with hydrogen and the evacuation of reaction products from the sheet surface into the furnace atmosphere.

According to the invention, the final annealing is carried out under pulsating hydrogen pressure in order to ensure the even rinsing of the entire sheet surface with hydrogen and the evacuation of reaction products from the sheet surface into the furnace atmosphere. At least one sheet made of a soft magnetic alloy, or a stack of sheets made of a soft magnetic alloy is heat treated or annealed at a temperature of between 400° C. and 1300° C. for a period of at least 15 minutes in a hydrogen-containing atmosphere, during this heat treatment the gas pressure level of the hydrogen-containing atmosphere being changed at least twice, preferably at least twice an hour.

For example, the gas pressure level is switched between a first predetermined gas pressure level G1 and a second predetermined gas pressure level G2 during the heat treatment, the gas pressure levels G1 and G2 being between 1 mbar and 200 bar, and the difference |G1-G2| being between 1 mbar and 200 bar, preferably between 10 mbar and 1 bar. The gas pressure level can be changed at least five times per hour during the heat treatment. At each change the gas pressure level is switched from G1 to G2 or from G2 to G1.

In further embodiments the gas pressure is switched between three or even more predetermined levels.

The present invention thus describes a method in which gas exchange is improved by means of pressure fluctuations even when parts are positioned close together. This enables both the hydrogen to better penetrate the gaps between the parts and reaction products to be better evacuated. The benefit of the invention therefore lies in the fact that in commercially viable set-ups of this type the reaction between the hydrogen and the surface of the sheet or part required to set the soft magnetic properties can be significantly improved, thereby achieving good magnetic properties more reliably.

### Mechanism and Effect of the Hydrogen Purification Action

The cleaning or purification action of hydrogen is explained here with reference to the element sulphur using the example of NiFe alloys. Depending on the desired soft magnetic properties, these soft magnetic NiFe alloys contain 30% to 82 wt % Ni and a total of less than 10 wt % Mo and/or Cr and/or Cu. They also typically contain 0.5 wt % Mn and up to 0.25 wt % Si for the purposes of deoxidation. To achieve the best possible soft magnetic properties, alloys of this type are smelted with as little sulphur as possible. To achieve this, raw materials containing as little sulphur as possible are used. However, it is also possible to carry out targeted desulphurisation of the melt by the addition of appropriate amounts of cerium mischmetal, for example. Despite all these measures, however, once poured off and solidified the alloy ultimately still contains a residual sulphur content that may range from a few ppm to several tens of ppm depending on the smelting process and practices used. Due to the Mn content of these alloys, where no cerium is used sulphur remains present in the form of manganese sulphide (MnS) because, according to the thermodynamic data provided by O. Knacke, O. Kubaschewski, K. Hesselmann in Thermochemical Properties of Inorganic Substances, 2nd Edition 1991, Springer-Verlag, the equilibrium constant K(T) for the equation

MnS⇄Mn+S (I)

at a typical annealing temperature of 1150° C. is K(1150° C.) =2.24×10⁻¹². If one then considers the thermodynamic stability of the MnS during annealing in hydrogen with the equation

MnS+H₂⇄Mn+H₂S (II)

the equilibrium constant K(T) is

$$K ( T ) = \frac{{a}_{Mn} \times p ( {H}_{2} S )}{{a}_{MnS} \times p ( {H}_{2} )} .$$

Here a_{Mn}, is the activity of Mn in the alloy and

α_{Mn}=γ_{Mn}×c_{Mn}

with an activity coefficient y_{Mn} and a concentration c_{Mn} The activity of MnS as a pure phase is a_{Mns}=1. When annealing in pure dry hydrogen p(H₂)=1 bar. The equilibrium pressure of hydrogen sulphide p(H₂S) therefore occurs at a given temperature in equilibrium in a closed system. This equilibrium pressure can be calculated using the thermodynamic data. For the aforementioned equilibrium reaction (II) at an annealing temperature of 1150° C., for example, the equilibrium constant K (1150° C.) calculated using the data provided by O. Knacke, O. Kubaschewski, K. Hesselmann in Thermochemical Properties of Inorganic Substances, 2nd Edition 1991, Springer-Verlag is 7.88×10⁻⁷. If, not knowing the exact activity coefficient of Mn in the alloy, one then simplifies the equation and assumes y_{Mn}=1 and so am, =0.5%, this gives an equilibrium pressure of hydrogen sulphide of p(H₂S)=0.16 mbar at 1150° C. This partial pressure of H₂S would occur in a closed system in equilibrium.

In practice, however, the most effective possible rinsing of the annealing material is achieved with hydrogen at a given hydrogen throughflow. In laboratory operation, for example, optimum results are customarily achieved on annealed samples made of soft magnetic alloys of this type in a tube furnace of approx. 10 cm diameter with a hydrogen rinsing rate of 500 I/h (at room temperature 20° C.). With the annealing material placed in a temperature-constant zone of approx. 10 cm (volume thus 10³×π/4≈0.79 I) at an annealing temperature of 1150° C. the calculated rate of gas exchange is therefore over 3,000 times per hour. This is not practicle in large bell-type or chamber furnaces of the type typically used in manufacturing. With furnace volumes of 1 to 2 m³ the amounts of hydrogen required would be excessive. Annealing furnaces of this type are typically operated with hydrogen quantities of 10 to 20m³/h. In such cases, the calculated gas exchange rate at an annealing temperature of 1150° C. is 48 to 97 times per hour (assuming ideal gas for the purposes of simplification).

In order to make the gas exchange over the annealing material as effective as possible, in furnaces of this type the hydrogen is often supplied via so-called “showers”, i.e. pipes with very small lateral bores distributed throughout the furnace chamber to ensure that the supply of fresh hydrogen is distributed as evenly as possible over the annealing material. The gas exchange produced in this manner results in the evacuation of H₂S as the hydrogen sulphide is effectively rinsed away as the gas is exchanged. Since it is an equilibrium reaction, however, the system effectively lags behind the equilibrium as new hydrogen sulphide is formed with the sulphur from the alloy. It is therefore possible to achieve effective cleaning of the alloy with regard to sulphur by means of final annealing in hydrogen at the highest possible temperatures, i.e. a sufficiently high equilibrium pressure p(H₂S), i.e. the sulphur content decreases significantly.

This also applies if the sulphur is dissolved rather than bound in the alloy. The equilibrium constant of this reaction would then be

$$K ( T ) = \frac{P ( {H}_{2} S )}{{a}_{s} \times p ( {H}_{2} )} \qquad ( III )$$

with aₛ as the activity of the sulphur dissolved in the alloy—the equilibrium pressure p(H₂S) would be another. In both cases the principle of the cleaning action would be the same.

Analogous observations can be made for the carbon dissolved in the alloy or the carbides formed in the alloy. There is then an equilibrium pressure of methane CH₄ and, with the hydrogen rinsing, an analogous cleaning action with regard to the carbon content of the alloy. The same behaviour occurs with dissolved oxygen and nitrogen and with oxides and nitrides present in the alloy. Here, too, there final annealing in hydrogen produces a cleaning action.

In annealing processes in a mixed gas such as a mix of nitrogen and hydrogen, for example, the hydrogen partial pressure must, of course, also be taken into consideration. In cracked ammonia gas it is 0.75 bar, for example. The equilibrium pressure of H₂S or CH₄, for example, changes accordingly, giving p(H₂S)=0.16 mbar×0.75=0.12 mbar in the example described above. However, it makes no difference to the basic principle of the cleaning action for sulphur, carbon and oxygen even in N₂/H₂ gas mixtures of this type, although the cleaning action is less effective at a lower H₂ partial pressure since the equilibrium pressure of the reaction product decreases.

With regard to the N content of the alloy, annealing in such mixtures can naturally result in nitridation if the alloy contains N-affine elements and the N₂ content of the annealing atmosphere is above the equilibrium pressure of the corresponding reaction.

With regard to the O content of the alloy, the determining factor is the thermodynamic stability of the strongest oxide former in der alloy. In the absence of hard oxide formers such as Mg, Ca, Ce, etc., this can often be Si, for example. It is clearly only possible to reduce the SiO₂ formed due to the residual oxygen content of the alloy if the hydrogen used is dry enough, i.e. the sum of its H₂O and O₂ contents result in a H₂O partial pressure at the annealing material below the equilibrium pressure p(H₂O) of the corresponding reaction (e.g. SiO₂+2H₂⇄Si+2H₂O).

In particular, tests on the annealing behaviour of the alloy VACOFLUX X1 (composition: 17% Co, 1.5% V, 0.2% Si and the rest Fe) have shown that in order to set the cube-face texture essential for very good soft magnetic properties a bright, oxide-free surface must imperatively be present, at least during cooling from the austenitic y-region through the α+γ to two-phase region to the ferritic a-region. Since SiO₂ is the most thermodynamically stable oxide in the usual composition of the alloy, the observations below are made with reference to SiO₂.

The equilibrium reaction for the oxide SiO₂ during annealing in hydrogen H₂ is as follows:

SiO₂+2H₂⇄Si+2H₂O (IV)

According to the thermodynamic data provided by O. Knacke, O. Kubaschewski, K. Hesselmann in Thermochemical Properties of Inorganic Substances, 2nd Edition 1991, Springer-Verlag, the equilibrium constant K(T) at a typical annealing temperature of 1000° C. is K(1000° C.)=3.79×10⁻¹⁴. If one then considers the thermodynamic stability of the SiO₂ during annealing in hydrogen with reaction (IV), the equilibrium constant K(T) is

$$K ( T ) = \frac{{a}_{Si} \times {p}^{2} ( {H}_{2} O )}{{a}_{{SiO}_{2}} \times {p}^{2} ( {H}_{2} )} . \qquad ( V )$$

Here aₛᵢ is the activity of Si in the alloy, and

(VI) (VI)

with an activity coefficient yₛᵢ, and a concentration cₛᵢ. The activity of SiO₂ as a pure phase is a_{siO2}=1. When annealing in pure, dry hydrogen p(H₂)=1 bar. The equilibrium pressure of water vapour p(H₂O) therefore occurs at a given temperature in equilibrium in a closed system. This equilibrium pressure can be calculated using the thermodynamic data. For the aforementioned equilibrium reaction (IV) at an annealing temperature of 1000° C., for example, the equilibrium constant K(1000° C.) calculated using the data provided by O. Knacke, O. Kubaschewski, K. Hesselmann in Thermochemical Properties of Inorganic Substances, 2nd Edition 1991, Springer-Verlag is 3.79×10⁻¹⁴. The concentration of Si in VACOFLUX X1 is typically 0.25 wt %, corresponding to approx. 0.5 mol %. According to the data provided by I. A. Vogel in Aktivitätskoeffizienten von Si und Cr in Fe—Ni-Legierungen und ihre Relevanz für die Thermodynamik planetarer Differentiationsprozesse, Inaugural-Dissertation der Mathematisch-Naturwissenschaftlichen Fakultät der Universität Köln, presented in December 2005, the activity coefficient of Si in Fe in a temperature range from 1250° C. to 1400° C. is of the order of 5×10⁻⁴. If a value of this order is also assumed for 1100° C., the activity as, at a concentration of 0.5 mol % is therefore aₛᵢ=2.5×10⁻⁶ mol %. Using equation (V), the calculated equilibrium water vapour pressure p(H₂O) at 1000° C. for annealing in hydrogen is therefore approx. 1.2 mbar. This corresponds to a saturation temperature of approx. −44° C. It is therefore possible to reduce SiO₂ at 1000° C. in hydrogen at a saturation temperature of less than −44°.

The formulas set out show that the effectiveness of the cleaning action depends substantially on the rinsing rate and gas exchange. If, for example, a “dead” region in which no effective gas exchange takes place occurs in a large annealing furnace due to the poor design of the rinsing equipment, magnetic quality in this region may be significantly poorer, e.g. have a significantly lower permeability level, depending on the alloy and its sensitivity with regard to the quality of the final annealing.

This is particularly true of sheets for annealing. For example, flux rings for high-speed motors made of NiFe alloys such as PERMENORM® 5000V5, MEGAPERM© 40L and ULTRAVAC® 44V6 are produced in very large quantities. These flux rings are manufactured from sheet thicknesses of 0.20 mm, 0.15 mm and even 0.10 mm. Final annealing must take place at temperatures of above 1.000° C. in dry hydrogen or in a H₂/N₂ gas mixture.

After final forming, parts made of soft magnetic alloys such as NiFe- or FeCo-based alloys, for example, are typically subjected to final annealing in a reducing atmosphere in order to achieve optimum soft magnetic properties. In addition to recrystallisation and grain growth, this also produces a cleaning action with regard to non-metallic impurities such as carbon, sulphur, nitrogen and oxygen.

One example of this type of heat treatment is the annealing of sheets of PERMENORM 5000 V5 (49% Ni, rest Fe) at typical temperatures of 1100° C. to 1150° C. in a dry hydrogen-containing atmosphere with a saturation temperature of −30° C. or better. The use of H₂ results in a reduction of the S content in the sample. Since S impurities lead to a deterioration in soft magnetic properties, rinsing with hydrogen is advantageous.

A further example is the annealing von VACODUR 49 (49% Co, 1.9% V, 0.1% Nb, rest Fe) in dry hydrogen at a temperature of 880° C. While no sulphur reduction takes place at this low temperature, the H₂ atmosphere prevents the formation of the vanadium oxides and nitrides that would otherwise result in a deterioration of the soft magnetic properties.

A further example is the annealing of VACOFLUX X1 (17% Co, 1.5% V, 0.2% Si, rest Fe) at a temperature of 1000° C. The advantageous magnetic properties of this alloy are achieved by the formation of a {100}<uvw>cube-face texture at which the magnetically soft axis lies in the strip plane. To set this texture, it is advantageous for the surface to be free of surface to oxides during cooling and the passage through the mixed ferritic-austenitic region, i.e. within a temperature range of 1000° C. and 900° C. This is ensured by hydrogen rinsing during cooling.

In the high-performance motor and generator sector, stator and rotor sheets made of 50% CoFe alloys such as VACOFLUX® 48, VACOFLUX® 50, VACODUR® 49 and VACODUR® 50 are manufactured in thicknesses of 0.35 mm right down to 0.050 mm. In some cases, final annealing is carried out on sheets (e.g. sheets of approx. A4 size) that are stacked on a flat annealing substrate in the furnace. These finish-annealed sheets can then be glued together to form a core, and this glued stack of sheets can be electric discharged machined to form the stator geometry.

When annealing this type of rotor or stator lamination, and particularly when annealing large sheets, in addition to the fundamental question of how to achieve the most effective rinsing of the annealing material across the entire furnace chamber possible there is also the inherent problem that gas exchange between the sheets is very considerably hampered when the sheets are stacked. This is also true of the annealing of whole laminated cores that have been produced by means of in-die stacking or laser welding, for example. It also applies to the annealing of sheets made of 80% NiFe alloys (such as MUMETALL®) for shielding cabins, where numerous sheets with thicknesses of 0.5 mm or 0.75 mm, a strip width of up to 65 cm and a length of the order of 1 m are subjected to the necessary final annealing in hydrogen in stacks.

### Diffusion in Gases

When annealing sheet stacks, the decomposition product of the impurity, e.g. H₂S, should occur in the gas exchange in order to achieve a cleaning action. In a sheet stack with small distances between the sheets there is no rinsing in the sense of through flushing with fresh hydrogen as takes place in the rest of the free furnace volume outside the sheet stack. Through flushing in the free furnace volume means that the remaining concentration is very small, close to zero. Due to a lack of flushing that occurs in the gaps between the sheets, it is possible to assume that the equilibrium pressure occurs in the gaps between the sheets. This means, however, that due to the higher concentration between the sheets compared to the rest of the free furnace volume a concentration gradient occurs and so diffusion takes place.

Equation (VII) below expresses the mean free path length λ that a gas molecule can travel without colliding with another gas molecule at a pressure ρ:

$$λ \times p = \frac{k \times T}{\sqrt{2 \times π \times {d}_{m}^{2}}} . \qquad ( VII )$$

Table 1 shows λ×ρ values for selected gases at 0° C. together with the molecular diameter dₘ calculated from these values.

TABLE 1

| | λ × p @ | Calculated |
|---|---|---|
| Gas | 0° C. (m Pa) | dₘ (nm) |
| H₂ | 11.5E−3 | 0.272 |
| N₂ | 5.9E−3 | 0.379 |
| O₂ | 6.5E−3 | 0.361 |
| H₂O | 6.8E−3 | 0.353 |
| CO₂ | 4.0E−3 | 0.461 |
| NH₃ | 3.2E−3 | 0.515 |

Diffusion into gases is expressed by equation (VIII) below:

D=⅓×v̅×λ (VIII)

where λ is the mean free path length and v̅ the mean speed of the gas molecules.

Furthermore, in the case of a gas mixture equation (IX) below expresses the mean square of the speeds:

½×Mᵢ×v̅ᵢ̅²̅= 3/2×R×T (IX)

where Mᵢ indicates the molar weight. The diffusion coefficient D₁₂ in a gas mixture is then (X):

$${D}_{12} = \frac{1}{3} \times {λ}_{12} \times \sqrt{( \overline{{v}_{1}^{2}} + \overline{{v}_{2}^{2}} )} \qquad ( X )$$

Equation (XI) below expresses the mean free path length λ₁₂ in gas mixtures:

$${λ}_{12} = \frac{1}{\sqrt{2 \times π \times {N}_{A} \times ( {c}_{1} + {c}_{2} ) \times {( {r}_{1} + {r}_{2} )}^{2}}} \qquad ( XI )$$

With concentrations c₁ and c₂, and molecular radii r₁ and r₂.

At a molecular weight of hydrogen H₂ of 2.01594 g/mol, the mean speed v̅(H₂) at a temperature T=1150° C. is therefore 4196 m/s.

At a molecular weight of hydrogen sulphide H₂S of 34.07994 g/mol, the mean speed v̅(H₂S) at a temperature of 1150° C. is therefore 1021 m/s.

When annealing in dry hydrogen, at a total pressure of 1 bar and an assumed partial pressure of hydrogen sulphide p(H₂S) of 0.16 mbar the hydrogen partial pressure p(H₂) is 0,99984 bar.

At 0° C. the molar volume of an ideal gas is 22.4 I/mol. Assuming ideal behaviour, at 1150° C. the molar volume is greater by a factor of (1,150+273.15)/273.15=5.21, i.e. 116.7 I/mol. This gives the following concentrations for calculating the mean free path length at 1150° C.:

c(H₂)=999.84I/m³/116.7 I/mol=8.5676 mol/m³
c(H₂S)=0.16I/m³/116.7 I/mol=1.371E-3 mol/m³.

It can be inferred from the table above that the molecular radius of hydrogen is r(H₂)=d/2=0.136 nm. Equation /6/ for the kinetic diameter gives a molecular radius of 0.18 nm for H₂S. Applying this value, the mean free path length at 1150° C. is λ₁₂=437nm. This then gives D₁₂=6.29E−4m²/s for the diffusion coefficient at 1150° C.

For the mean diffusion path:

x̅√\vec{=2Dt} (XII)

This then gives x̅=4.76m for annealing at 1150° C. for 5 h. Tables 2 and 3 below show the calculated results for various annealing temperatures.

Table 2 shows sample calculations for the mean speeds of the gas molecules.

TABLE 2

| | Molar | | Molecular | | |
|---|---|---|---|---|---|
| | weight | | radius | T | υ̅ |
| Gas | (g/mol) | p (bar) | (nm) | (° C.) | (m/s) |
| H₂ | 2.01594 | 0.99984 | 0.136 | 1,150 | 4,196 |
| | | | | 1,050 | 4,046 |
| | | | | 910 | 3,826 |
| H₂S | 34.07994 | 0.00016 | 0.18 | 1,150 | 1,021 |
| | | | | 1,050 | 984 |
| | | | | 910 | 931 |

Table 3 shows sample calculations for the mean diffusion path in an H₂/H₂S gas mixture.

TABLE 3

| Gas | Gas | T | ν̅_{A} | ν̅_̅{̅B̅}̅ | λ₁₂ | D₁₂ | t | √(2Dt) |
|---|---|---|---|---|---|---|---|---|
| A | B | (° C.) | (m/s) | (m/s) | (nm) | (m²/s) | (h) | (m) |
| H₂ | H₂S | 1,150 | 4,196 | 1,021 | 437 | 6.29E−4 | 5 | 4.76 |
| | | 1,050 | 4,046 | 984 | 406 | 5.64E−4 | 5 | 4.50 |
| | | 910 | 3,826 | 931 | 363 | 4.76E−4 | 5 | 4.14 |

If one considers the result for the mean diffusion path of a few metres and relates it to the lateral dimensions during the annealing of sheets made from soft magnetic alloys, e.g. 30 cm, or the annealing of stator and rotor laminations (a few cm), at first glance the diffusion should ensure that cleaning takes place. However, a characteristic pattern of annealing colours can often be observed on annealed sheets, whereas exterior sheets with free access to the hydrogen look bright. It can be assumed that the hydrogen in the annealing atmosphere is unable to fully deploy its cleaning action in the narrow gaps between the sheets. This may be due to the fact that a concentration gradient of the corrosive gas to be evacuated (e.g. H₂S) is only able to develop fully at the edge of the sheet stack because in the interior the system will always tend toward the setting of the equilibrium pressure p(H₂S) as long as there is still sufficient sulphur in the alloy and so follows the diffusion of sulphur onto the surface.

Landolt-Börnstein, New Series Group III, Vol. 26, p. 130 gives the following data for the diffusion of sulphur in Fe:
For α Fe in a T range of 700° C. to 900° C.: Dₒ =34.6 cm²/s, Q=231.5 kJ/mol.
For γ Fe in a T range of 950° C. to 1250° C.: Dₒ=1.7 cm²/s, Q=221.9 kJ/mol.

The data for γ Fe gives a mean diffusion path √(2Dt) for sulphur of 0.21 mm for the annealing conditions assumed in Table 2 of 5 h/1150° C.

According to the thermodynamic data provided by O. Knacke, O. Kubaschewski, K. Hesselmann in Thermochemical Properties of Inorganic Substances, 2nd Edition 1991, Springer-Verlag, when sulphur is present in the alloy as MnS, as is typically the case, the calculated solubility equilibrium of S is well under 1 ppb at the typical annealing temperatures of approx. 1000° C. and 2 ppb at 1150° C. In such a case (S bound in the alloy as MnS), the equilibrium pressure of hydrogen sulphide p(H₂S) depends only the activity of the Mn in the alloy and the hydrogen partial pressure, neither of which change during annealing. In such a case there are, therefore, no gradients in the gaps between the sheets whatever the sulphur content, as long as it remains above the equilibrium concentration of sulphur in the alloy. Given the diffusion path determined, this should however be the case.

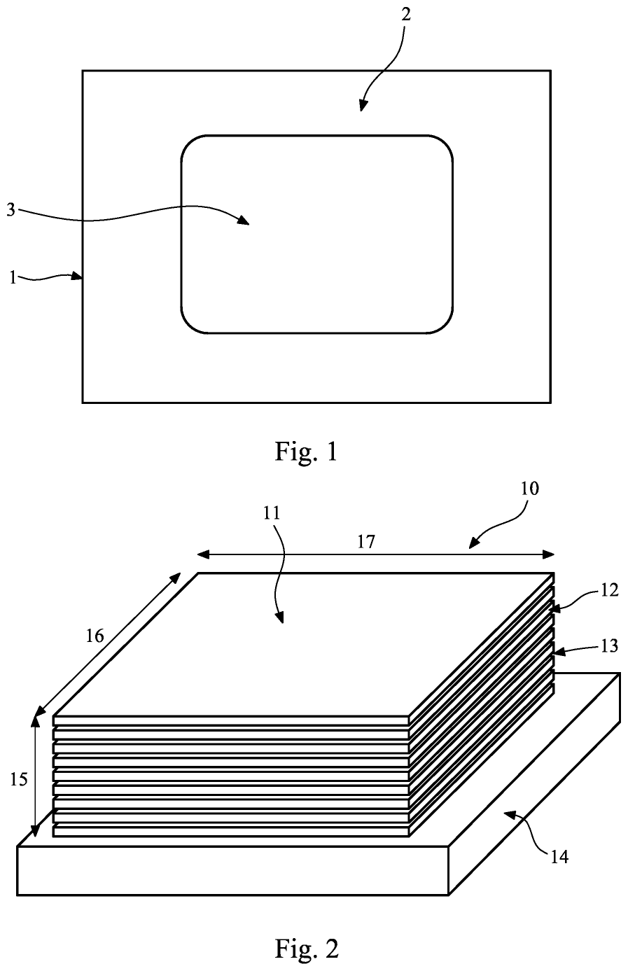

These considerations apply analogously to impurities of oxygen, nitrogen and carbon in so far as they are bound to a strong oxide former or nitride or carbide former. The unsatisfactory cleaning action and typical appearance of sheets that are annealed packed closely in stacks explain why the only real concentration gradient occurs at the edge of the sheet stack. FIG. 1 shows a schematic comparative example of the effect of insufficient hydrogen rinsing of sheets due to annealing in a sheet stack, in which the gas pressure of the hydrogen is kept almost constant. The edge region 2 of the sheet 1 is metallically bright as the hydrogen was able to act here, while the central region 3 tarnished.

This appearance of stack-annealed sheets is also observed for sheets made of the VACOFLUX X1 alloy that are given a structured coating of the ceramic-forming TX1 coating to ensure layer separation but also have sufficient free surface. This sheet was annealed in the centre of a stack of sheets at 1,000° C. for 4 h in dry hydrogen at a saturation temperature of below −40° C. In addition to the continuous net-like coating, it is also possible to see alongside to the metallically bright edge region a matt-looking region in the centre caused by V and above all Si oxides. The saturation temperature in the centre was clearly not low enough to reduce these oxides in hydrogen. In contrast, the outside of the top sheet of the stack was bright all over.

### Pressure Loss Between Stacked Sheets

The above remarks on the diffusion of gases apply to annealing with unlimited gas exchange between sample surface and furnace atmosphere. In the cases relevant to the invention, however, gas exchange is reduced because the sheets or parts are packed closely together. FIG. 2 shows an example of an annealing set-up 10 in a stack. A sheet stack 11 comprising a plurality of sheets 12 stacked one on top of another with corresponding gaps 13 between them is arranged on an annealing substrate 14. Optionally, the stack may also be weighted down with a covering plate (not shown). The sheet stack has a height 15 resulting substantially from the product of the sheet thickness of the sheets 12 and the number of sheets since the height of the gaps is very small compared to the sheet thickness. The sheets also have a width 16 and a length 17. The hydrogen or hydrogen-containing gas is able to penetrate the gaps 13 from the side during annealing.

FIG. 2 shows a simplified illustrattion of the annealing of sheets in a stack. The gaps 13 between the sheets 12 are shown greatly enlarged and the number of sheets is often much greater in practice, giving a greater height 15.

This through flushing of a stack of sheets is similar to the conditions under which a gaseous coolant is through flushed through plate heat exchangers. The pressure loss due to this type of sheet stack and the flushing speed are described in Estimating Parallel Plate-fin Heat Sink Pressure Drop, Electronics Cooling Magazine, www.electronics-cooling.com/2003/05/estimating-parallel-plate-fin-heat-sink-pressure-drop/#, for example.

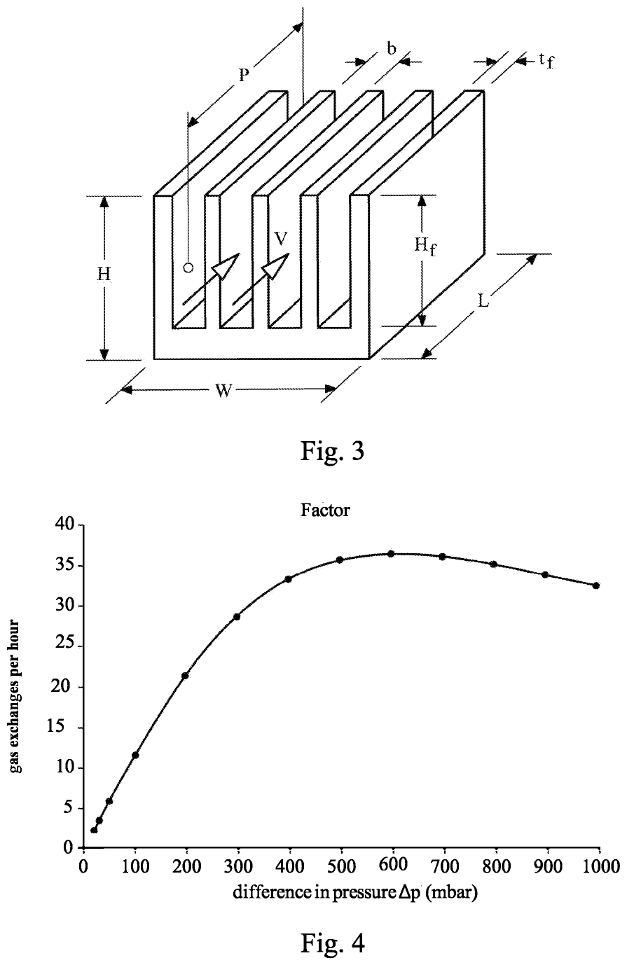

FIG. 3 shows the dimensions of the sheet stack and the formula symbols used. The observations made here always assume H_{f}═H, i.e. a simple stack of sheets. When sheets, i.e. thin metal sheets made of soft magnetic alloys, are annealed they are typically stacked in the annealing chamber. The sheet thickness t_{f} of 0.2 mm, for example, is significantly greater than the gap between the sheets b, such that t_{f}>>b. This substantially simplifies the formulae to be used. Only those formulae from Estimating Parallel Plate-fin Heat Sink Pressure Drop, Electronics Cooling Magazine, www.electronics-cooling.com/2003/05/estimating-parallel-plate-fin-heat-sink-pressure-drop/# that are required for this case are shown below; they are also simplified accordingly for t_{f}>>b.

FIG. 3 shows the dimensions of the sheet stack and the formula symbols used:

The following simplified relationships s apply for t_{f}>>b:

Gap between sheets b:

$$b = \frac{W - {N}_{fin} \times {t}_{f}}{{N}_{fin} - 1} \qquad ( XIII )$$

The hydraulic diameter Dₕ≈2b/7/.

The following relationship /7/ applies for the Reynolds number Rₑ:

$${R}_{e} = \frac{ρ \times v \times {D}_{h}}{μ} , \qquad ( XIV )$$

where ρ is the density, v the flow rate of the gas between the sheets and μ is the dynamic viscosity of the gas.

In this case with its extremely small aspect ratio A=b/H_{f}=b/H, the friction factor can be assumed to be f=24 /Rₑ for the purposes of simplification. The pressure drop Δp is then expressed in simplified terms by the following relationship:

$$Δ p = \frac{4 \times f \times L \times ρ \times {v}^{2}}{2 {D}_{h}} = \frac{48 \times μ \times L \times v}{{D}_{h}^{2}} , \qquad ( XV )$$

where μ is the dynamic viscosity.

Conversely, the flow rate v for a given difference in pressure is expressed as:

$$v = \frac{Δ p \times {D}_{h}^{2}}{48 \times μ \times L} . \qquad ( XVI )$$

Table 3 shows data on the dynamic viscosity of hydrogen H₂, and Table 4 shows data on the dynamic viscosity μ of hydrogen taken from Gases-Dynamic Viscosity, The Engineering Toolbox, www.engineeringtoolbox.com/gases-absolute-dynamic-viscosity-d_1888. html.

TABLE 4

| T (° C.) | 0 | 20 | 50 | 100 | 200 | 300 | 400 | 500 | 600 |
|---|---|---|---|---|---|---|---|---|---|
| μ (10⁻⁵ Pa s) | 0.84 | 0.88 | 0.94 | 1.04 | 1.21 | 1.37 | 1.53 | 1.69 | 1.84 |

A linear regression of this data permits their extrapolation to higher temperatures. The result of the linear regression of this data from Table 3 is:
μ0.0017×T+0.4043 (where T is in K and p in 10⁻⁵ Pa·s).

For T=1000° C. this gives p =2.57×10⁻⁵ Pa s, for example.

The effect of pulsating hydrogen pressure is illustrated by the following examples.

### A. Final Annealing According to a Comparative Example (Not According to the Invention):

Annealing chamber volume: 1.0 m³
Rinsing rate (H₂): 12 m³/h at room temperature 20° C.
Overpressure: 10 mbar (no change in gas pressure)
Calculated gas exchange in furnace volume per h: 58x (calculated at an annealing temperature of 1150° C.—ideal gas)
Annealing time: 5 h

However, the gas exchange between stacked sheets here is very low here since convection between the sheets is severely hampered, and the contribution made by diffusion is also restricted due to the fact that concentration gradients form only at the edges of the laminated core. The equilibrium pressure of H₂S forms between the sheets. Only the portion removed by convection and diffusion contributes to the cleaning action. As a result, optimally effective cleaning is impossible for stacked sheets.

### B. Annealing Under Pulsating Hydrogen Pressure (According to the Invention):

Annealing chamber volume: 1.0 m³
Flushing rate (H2): 58 m³/h (at an annealing temperature of 1150° C.)
Overpressure level 1: 10 mbar
Overpressure level 2: 30 mbar
Annealing time: 5 h

At the specified rinsing rate and furnace volume the time required to build up the pressure from 10 mbar to 30 mbar is 0.02×1/58=0.000345 h=1.24 s. If the pressure drop from 30 mbar back to 10 mbar then takes place in the same time, for example, this pressure fluctuation is achieved a total of 3.600/(1.24+1.24)=1.452 times per hour. In mathematical terms, this means that approx. 2% of the gas (corresponding to a difference in pressure of 20 mbar) is replaced each time. The gas is therefore exchanged 29 times in one hour, with the difference that this procedure can also achieve effective gas exchange between the sheets due to the differences in pressure.

If, for example, this furnace volume contains 100 kg of annealing material made of an alloy with a sulphur content of 50 ppm, the H₂ in the annealing atmosphere would form and evacuate 5.31 g of H₂S from the 5.00 g sulphur content of the alloy. At an H₂S molar volume of 22.18 I/mol (Tabellensammlung_Chemie/_Dichte_gasfC3%B6rmiger_Stoffe available at de.wikibooks.org/wiki/Tablensammlung_Chemie/_Dichte_gasf%C3%B6rmiger_Stoffe) that is 3.461 of H₂S gas, or at 1150° C. under the simplifying assumption of ideal behaviour approx. 181. At an H₂S equilibrium pressure of 0.16 mbar, as calculated above by way of example and corresponding to 0.161 in the 1 m³ furnace volume, complete gas exchange is calculated to take place 145 times during an annealing period of 5 h. A simple estimate of 145×0.16=23.2>18 shows that more effective cleaning can be achieved using this method.

A complicating factor here, however, is that due to flow resistance in the narrow gaps between the sheets the overpressure between the sheets can only build up slowly.

C. Example According to the Invention

A sheet stack of sheets with the following measurements: 300×300mm², thickness 0.20 m, sheet spacing in the stack 3pm, annealing temperature 1000° C., annealing atmosphere pure dry hydrogen is passed through a furnace at 10 mbar overpressure for safety reasons and with the overpressure pulsated between p₁=10 mbar and a greater overpressure level p₂ (e.g. 30 mbar, i.e. Δp=20 mbar). The furnace volume is 0.5m³, the H₂ rinsing rate is 10m³/h (measured at room temperature, gives approx. 43.4m³/h at 1000° C.). Hydrogen density at 20° C. ρ is 0.08988 g/I.

Based on the formulae given above it is then possible to calculate as follows:
Hydraulic cross section: Dₕ=6 μm
Aspect ratio: A=10⁻⁵ (permitting use of simplified formulae)
Reynolds number: Rₑ=9.41×10⁻⁷
Friction factor: f=2.55×10⁷
Density of H₂ at 1000° C.: ρ=0.0207 g/l (calculated as ideal gas)
Time for pressure build-up to 20 mbar at 1000° C.: 0.83 s

Using formula (XVI) a flow rate of v=0.195mm/s is calculated for a difference in pressure of 20 mbar. The flow is thus calculated to take approx. 770 s to reach the centre of the sheet. If the same times are assumed for the build-up of pressure, the cycle time for pressure build-up +flow time to the centre of the sheet is thus approx. 1542 s. Mathematically, it is therefore possible to achieve a gas exchange 2.33 times per hour. If the difference in pressure Δp is increased, the flow rate obviously increases too, but at the given rinsing rate the pressure-build-up time is then longer. FIG. 4 shows the gas exchange rates between the sheets calculated in this manner as a function of the difference in pressure Δp.

This is merely a rough estimate of the gas exchange rate since the estimate of the flow and so the estimate of the time to pressure equalisation in the centre of the sheet stack was carried out in a very simplified manner. However, the estimates do show that by selecting appropriate process and equipment parameters (e.g. difference in pressure Δp, H₂ rinsing rate, pressure drop time in furnace volume, sheet stack density and so gap size between sheets, etc.) it is possible to ensure gas exchange between the sheets by pulsating the hydrogen pressure during final annealing, and so achieve an improved cleaning action and thus better soft magnetic properties.

The heat treatment conditions, in particular temperature and time, are set independently of the composition of the soft magnetic alloy. For the final annealing of sheets of PERMENORM 5000 V5 (49% Ni, rest Fe) it is possible to use a temperature of typically 1100° C. to 1150° C. in a dry hydrogen atmosphere with a saturation temperature of −30° C. or better. The use of H₂ results in a reduction in the S content in the sample. As S impurities lead to a deterioration in soft magnetic properties, hydrogen rinsing is advantageous.

A temperature of 880° C. can be used for the final annealing of VACODUR 49 (49% Co, 1.9%V, 0.1% Nb, rest Fe) in dry hydrogen. While almost no reduction in sulphur takes place at this temperature since the equilibrium pressure p(H₂S) at this lower temperature is very low, the H₂ atmosphere does hamper the formation of vanadium oxides and nitrides that would otherwise lead to a deterioration in soft magnetic properties.

A temperature of 1000° C. can be used for the final annealing of VACOFLUX X1 (17% Co, 1.5% V, 0.2% Si, rest Fe). The advantageous magnetic properties of this alloy are achieved by the formation of a cube-face texture {100}<uvw> at which the magnetically soft axis lies in the strip plane. To set this texture, it is advantageous for the surface to be free of near-surface oxides during cooling and the passage through the ferritic-austenitic mixed region, i.e. in a temperature range of between 1000° C. and 900° C. This can be achieved by means of hydrogen rinsing during cooling.

A pulsating gas pressure can naturally also be used during any necessary oxidation of the sheets in order to homogenise the oxide layer produced for layer insulation. Once final annealing in a hydrogen-containing atmosphere has been carried out, the sheet surface is then oxidised in a separate annealing process or annealing stage in order to achieve an electrical insulation effect. This is achieved by annealing within a temperature range of 350° C. to 600° C. in air and/or a hydrogen-containing atmosphere. It is thus also possible to homogenise surface oxidisation in stacked sheets or laminated cores by changing the pressure level.

In some embodiments, final annealing is carried out in a hydrogen-containing atmosphere at almost constant gas pressure or with changing pressure according to any one of the embodiments described here, then the sheet surface is oxidised using a pulsating gas pressure in a hydrogen-containing atmosphere such as air and/or an atmosphere containing water vapour.

### FURTHER EXAMPLES

Example 1 A method for the production of a stack of sheets with improved soft magnetic properties, wherein in order to achieve these soft magnetic properties the gas exchange between the sheets is improved during final annealing in a hydrogen-containing annealing atmosphere by the repeated changing of the gas pressure level during annealing.

Example 2 A method according to example 1, wherein the gas pressure level is varied within a range between a vacuum and an overpressure level of 200 bar.

Example 3 A method according to example 2, wherein the gas pressure level is varied between an overpressure level of 10 mbar (10 mbar above ambient pressure) and an overpressure level of 1 bar, preferably between 50 mbar and 1 bar overpressure.

Example 4 A method according to any one of examples 1 to 3, wherein the annealing takes place stationarily in a batch furnace.

Example 5 A method according to any one of examples 1 to 3, wherein the annealing takes place in a continuous furnace with an appropriate gas lock function to enable pressure fluctuations in the furnace chamber.

Example 6 A method according to any one of examples 1 to 5, wherein the gas pressure level is changed at least five times per hour.

Example 7 A method according to any one of examples 1 to 6, wherein the difference in pressure between the two gas pressure levels is at least 20 mbar, preferably at least 100 mbar.

Example 8 A method according to any one of examples 1 to 7, wherein the rate of gas exchange at the centre of the sheet taking into account the flow rate between the sheets is calculated to be at least five times per hour.

Example 9 A method for the production of a soft magnetic alloy according to any one of examples 1 to 8, comprising:
providing a preliminary product made of an FeCo alloy or a NiFe alloy, or having a composition consisting essentially of:

| | | |
|---|---|---|
| 2 wt % | ≤Co | ≤30 wt % |
| 0.3 wt % | ≤V | ≤5.0 wt % |
| 0 wt % | ≤Cr | ≤3.0 wt % |
| 0 wt % | ≤Si | ≤5.0 wt % |
| 0 wt % | ≤Mn | ≤5.0 wt % |
| 0 wt % | ≤Al | ≤3.0 wt % |
| 0 wt % | ≤Ta | ≤0.5 wt % |
| 0 wt % | ≤Ni | ≤1.0 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

the rest iron and up to 0.2 wt % of other impurities due to melting,
the preliminary product having a phase transition from a BCC-phase region to a mixed BCC/FCC region to an FCC-phase region, as the temperature increases the phase transition between the BCC-phase region and the mixed BCC/FCC region taking place at a first transition temperature T_{α/α+y}, and as the temperature increases further the transition between the mixed BCC/FCC region and the FCC-phase region taking place at a second transition temperature T_{α+γ/γ}, where T_{α+γ/γ}and the difference T_{α+γ/γ}-T_{α/α+γ} is less than 45K, preferably less than 25K,
partially coating the preliminary product with a ceramic-forming layer, 20% to 80% of the total surface of the preliminary product remaining free of the ceramic-forming layer,
heat treating the partially coated preliminary product, the heat treatment comprising:
   heating up the preliminary product, and then
   heat treating the preliminary product in a first stage for a total time t₁, in the first stage the preliminary product being heat treated at a temperature within a temperature range of between T_{α+γ/γ}and T₁, and then
   cooling the preliminary product to room temperature, or
   heating up the preliminary product, and then
   heat treating the preliminary product in a first stage for a total time t₁, in the first stage the preliminary product being heat treated at a temperature within a temperature range of between T_{α+γ/γ}and T₁, and then
   cooling the preliminary product to a temperature T₂, and then
   heat treating the preliminary product in a second stage at temperature T₂ for a time t₂, and then
   cooling the preliminary product to room temperature,
the heat treatment being carried out for at least part of the time in a hydrogen-containing atmosphere and during this time the exposed parts of the surface of the preliminary product are in direct contact with the hydrogen-containing atmosphere, where T₁>T₂, T₁ is above T_{α+γ/γ}and T₂ is below T_{α/α+γ}.

Example 10 A method according to example 9, whrein after the heat treatment the alloy has an area proportion of a {111}<uvw>texture of no more than 13%, preferably no more than 6%, including grains with a tilt of up to +/−10° , or preferably up to +/- 15° , when compared to the nominal crystal orientation.

Example 11 A method according to either of examples 9 or 10, wherein after the heat treatment the alloy has an area proportion of a {100}<uvw>cube-face texture of at least 30%, preferably at least 50%, including grains with a tilt of up to +/−15° , or preferably up to +/−10° , when compared to the nominal crystal orientation.

Example 12 A method for forming an insulating layer on at least one sheet made of a soft magnetic alloy, the method comprising the following: heat treating at least one finally annealed sheet made of a soft magnetic alloy at a temperature of between 350° C. and 600° C. for a period of at least 15 minutes in a hydrogen-containing atmosphere such as air, for example, and/or in an atmosphere containing water vapour, wherein during this heat treatment the gas pressure level of the hydrogen-containing or water-vapour-containing atmosphere is changed at least twice.

Example 13. A method according to example 1, wherein during the heat treatment the gas pressure level is switched between a first predetermined gas pressure level G1 and a second predetermined gas pressure level G2, the difference |G1-G2| being between 1 mbar and 200 bar.

Example 14 A method according to example 13, wherein the difference |G1-G2| is between 10 mbar and 1 bar.

Example 15. A method according to any one of examples 12 to 14, wherein during the heat treatment the gas pressure is changed at least five times per hour.

Example 16. A method according to any one of examples 12 to 15, wherein a plurality of sheets are stacked one on top of another to form a stack, and the stack is heat treated.

Example 17. A method according to example 16, wherein the stack is weighted down with an additional weight and being heat treated with this weight, wherein the weight weighs at least 20%, preferably at least 50%, of the weight of the preliminary product.

Example 18. A method according to any one of examples 12 to 17, wherein the sheet or sheets also comprise an electrical insulating layer that has a thickness of 0.1 μm to 10 μm, preferably 0.1 μm to 5 μm, preferably 0.1 μm to 2 μm.

Example 19. A method according to any one of examples 12 to 18, wherein the sheet or sheets have a thickness of 0.05 mm to 1 mm, preferably 0.05 mm to 0.50 mm.

Example 20. A method according to any one of examples 12 to 20, wherein the heat treating takes place stationarily in a furnace.

Example 21. A method according to example 20, wherein the gas pressure is changed by activating a gas lock function in the furnace.

Example 22. A method according to any one of examples 12 to 21, wherein the sheet or sheets are made of an FeCo alloy or a NiFe alloy or an Fe-based alloy.

Example 23. A method according to any one of examples 12 to 21, wherein the sheet or sheets comprise a composition consisting essentially of:

| | | |
|---|---|---|
| 2 wt % | ≤Co | ≤30 wt % |
| 0.3 wt % | ≤V | ≤5.0 wt % |
| 0 wt % | ≤Cr | ≤3.0 wt % |
| 0 wt % | ≤Si | ≤5.0 wt % |
| 0 wt % | ≤Mn | ≤5.0 wt % |
| 0 wt % | ≤Al | ≤3.0 wt % |
| 0 wt % | ≤Ta | ≤0.5 wt % |
| 0 wt % | ≤Ni | ≤1.0 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

the rest iron and up to 0.2 wt % of other impurities due to melting,
the sheet or sheets having a phase transition from a BCC-phase region to a mixed BCC/FCC region to an FCC-phase region, as the temperature increases the phase transition between the BCC-phase region and the mixed BCC/FCC region taking place at a first transition temperature T_{α/α+γ}, and as the temperature increases further the transition between the mixed BCC/FCC region and the FCC-phase region taking place at a second transition temperature Ta_{α+γ/γ}.

Example 24. A method according to any one of examples 12 to 23, wherein before the heat to treatment in a hydrogen-containing atmosphere or an atmosphere containing water vapour a cold rolled sheet is subjected to final annealing in order to produce the finally annealed sheet.

Example 25 A method according to example 24, wherein the final annealing of the sheet comprises the heat treatment of at least one sheet at a temperature of between 400° C. and 1300° C. for a period of at least 15 minutes in a hydrogen-containing atmosphere, wherein during this heat treatment the gas pressure level of the hydrogen-containing atmosphere is changed at least twice.

Example 26. A method according to example 24 or 25, wherein in order to produce the sheet a strip is first provided, and this strip is then partially coated with a ceramic-forming layer, 20% to 80% of total surface of the preliminary product remaining free of the ceramic-forming layer, wherein the sheet or sheets are formed from the strip and the partially coated sheet or sheets are given a final annealing.

Example 27. A method according to example 26, wherein one side of the strip is partially coated such that 20% to 80% of the one side of the strip remains free of the ceramic-forming layer, or wherein two opposing sides of the strip are partially coated such that 20% to 80% of the two opposing sides of the strip remain free of the ceramic-forming layer.

Example 28. A method according to any one of examples 24 to 27, wherein the sheet or sheets are partially coated with a ceramic-forming layer, 20% to 80% of the total surface of the preliminary product remining free of the ceramic-forming layer and the partially coated sheet or sheets are given a final annealing.

Example 29. A method according to example 28, wherein one side of the sheet or sheets are partially coated such that 20% to 80% of the one side of the sheet or sheets remains free of the ceramic-forming layer, or wherein two opposing sides of the sheet or sheets are partially coated such that 20% to 80% of the two opposing sides of the sheet or sheets remain free of the ceramic-forming layer.

Example 30. A method according to any one of examples 24 to 29, wherein the final annealing comprises: heating the sheet and then heat treating the sheet in a first stage for a total time t₁, in the first stage the sheet being heat treated at a temperature within a temperature range of T_{α+γ/γ}to T₁, and then cooling the sheet to room temperature, wherein the final annealing is carried out for at least part of the time in a hydrogen-containing atmosphere and during this time the exposed parts of the surface of the sheet are in direct contact with the hydrogen-containing atmosphere, where T₁>T₂, T₁ is above T_{α+γ/γ} and T₂ is below T_{α/α+γ}.

Example 31. A method according to any one of examples 24 to 30, wherein the final annealing comprises: heating the sheet and then heat treating the sheet in a first stage for a total time t₁, in the first stage the sheet being heat treated at a temperature within a temperature range of T_{α+γ/γ}to T₁, and then cooling the sheet to a temperature T₂, and then heat treating the preliminary product in a second stage at temperature T₂ for a time t₂, and then cooling the sheet to room temperature, wherein the final annealing is carried out for at least part of the time in a hydrogen-containing atmosphere and during this time the exposed parts of the surface of the sheet are in direct contact with the hydrogen-containing atmosphere, where T₁>T₂, T₁ is above T_{α+γ/γ} and T₂ is below T_{α/α+γ}.

Example 32. A method according to any one of examples 23 to 31, wherein T_{α+γ/γ}>T_{α/α+γ}and the difference T_{α+γ/γ}-T_{α/α+γ}is less than 45K, preferably less than 25K,

Example 33. A method according to any one of examples 24 to 32, wherein after the final annealing the sheet or sheets have an area proportion of a {111}<uvw>texture of no more than 13%, preferably no more than 6%, including grains with a tilt of up to +1-10° , or preferably up to +/−15°, when compared to the nominal crystal orientation.

Example 34. A method according to any one of examples 24 to 33, wherein after the final annealing the sheet or sheets have an area proportion of a {100}<uvw>cube-face texture of at least 30%, preferably at least 50%, including grains with a tilt of up to +/−15° or preferably up to +/−10° when compared to the nominal crystal orientation.

Example 35. A method according to any one of examples 12 to 34, wherein in order to produce the sheet or sheets the method further comprises:

providing by use of vacuum induction melting, electro-slag remelting or vacuum arc remelting of a melt consisting essentially of:

| | | |
|---|---|---|
| 2 wt % | ≤Co | ≤30 wt % |
| 0.3 wt % | ≤V | ≤5.0 wt % |
| 0 wt % | ≤Cr | ≤3.0 wt % |
| 0 wt % | ≤Si | ≤5.0 wt % |
| 0 wt % | ≤Mn | ≤5.0 wt % |
| 0 wt % | ≤Al | ≤3.0 wt % |
| 0 wt % | ≤Ta | ≤0.5 wt % |
| 0 wt % | ≤Ni | ≤1.0 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

the rest iron and up to 0.2 wt % of other impurities due to melting, solidifying the melt to form an ingot,

mechanically deforming the ingot in order to produce a strip,
forming the sheet or sheets from the strip.

Example 36. A method according to example 35, wherein the mechanically deforming is carried out by hot rolling and/or forging and/or cold forming, the ingot being deformed by hot rolling at temperatures of between 900° C. and 1300° C. to form a slab and then to form a hot strip of thickness D₁, and then being deformed by cold rolling to form a strip of thickness D₂, where 0.05 mm≤D₂≤1.0mm and D₂<D₁.

Example 37. A method according to example 36, wherein the hot strip of thickness D₁ is first produced by continuous casting, then is deformed by cold rolling to form the strip of thickness D₂, where 0.05 mm≤D₂≤1.0 mm, preferably 0.05 mm≤D₂≤0.50 mm and D₂<D1, the degree of cold forming by cold rolling being >40%, preferably >80%, preferably >95%.

The annealing of soft magnetic alloys in hydrogen ensures an improved purification action owing to controlled pressure fluctuations. This enables good magnetic properties to be achieved reliably with relatively large parts and high furnace fill levels. A method and device that ensure effective gas exchange between sheets during final annealing are specified in particular for the final of annealing sheets or laminated cores.

In summary, final annealing is carried out under pulsating hydrogen pressure in order to ensure even rinsing of the complete sheet surface with hydrogen and evacuation of reaction products from the sheet surface in the furnace atmosphere. At least one sheet made of a soft magnetic alloy or one stack of sheets made of a soft magnetic alloy is heat treated or finally annealed at a temperature of between 400° C. and 1300° C. for a period of at least 15 minutes in a hydrogen-containing atmosphere, the gas pressure level of the hydrogen-containing atmosphere being changed at least twice during this heat treatment. For example, the gas pressure level is switched between a first predetermined gas pressure level G1 and a second predetermined gas pressure level G2 during the heat treatment. The difference |G1G2| may be that between a vacuum and 200 bar, preferably that between 10 mbar and 1 bar. The gas pressure level can be changed at least five times per hour during the heat treatment. In one change the gas pressure level is switched between G1 and G2 or between G2 and G1.

1. A method for heat treating at least one sheet made of a soft magnetic alloy, the method comprising the following:
heat treating at least one sheet made of a soft magnetic alloy at a temperature of between 400° C. and 1300° C. for a period of at least 15 minutes in a hydrogen-containing atmosphere, wherein during this heat treatment the gas pressure level of the hydrogen-containing atmosphere is changed at least twice.

2. A method according to claim 1, wherein during the heat treatment the gas pressure level is switched between a first predetermined gas pressure level G1 and a second predetermined gas pressure level G2, the difference |G1-G2| being between 1 mbar and 200 bar at least twice.

3. A method according to claim 2, wherein the difference |G1-G2| is between 10 mbar and 1 bar.

4. A method according to claim 1, wherein during the heat treatment the gas pressure level is changed at least five times per hour.

5. A method according to claim 1, wherein a plurality of sheets is stacked one on top of another to form a stack, and the stack is heat treated.

6. A method according to claim 5, wherein the stack is weighted down with an additional weight and heat treated with this weight, the weight weighing at least 20%, of the weight of the preliminary product.

7. A method according to claim 1, wherein the sheet or sheets further comprise having an electrical insulating layer that has a thickness of 0.1 μm to 10 μm.

8. A method according to claim 1, wherein the sheet or sheets have a thickness of 0.05 mm to 1 mm.

9. A method according to claim 1, wherein the heat treatment is performed stationarily in a furnace.

10. A method according to claim 9, wherein the gas pressure is changed by activating a gas-lock function of the furnace.

11. A method according to claim 1, wherein the sheet or sheets are made of an FeCo alloy or a NiFe alloy or an Fe-based alloy.

12. A method according to claim 1, wherein the sheet or sheets comprise a composition consisting essentially of:

| | | |
|---|---|---|
| 2 wt % | ≤Co | ≤30 wt %, |
| 0.3 wt % | ≤V | ≤5.0 wt %, |
| 0 wt % | ≤Cr | ≤3.0 wt %, |
| 0 wt % | ≤Si | ≤5.0 wt %, |
| 0 wt % | ≤Mn | ≤5.0 wt %, |
| 0 wt % | ≤Al | ≤3.0 wt %, |
| 0 wt % | ≤Ta | ≤0.5 wt %, |
| 0 wt % | ≤Ni | ≤1.0 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

the rest iron and up to 0.2 wt % of other impurities due to melting,
the sheet or sheets having a phase transition from a BCC-phase region to a mixed BCC/FCC region to an FCC-phase region, as the temperature increases the phase transition between the BCC-phase region and the mixed BCC/FCC region taking place at a first transition temperature T_{α/α+γ}, and as the temperature increases further the transition between the mixed BCC/FCC region and the FCC-phase region taking place at a second transition temperature T_{α+γ/γ}.

13. A method according to claim 1, wherein in order to produce the sheet a strip is first produced, and the strip then is partially coated with a ceramic-forming layer, whereby 20% to 80% of the total surface of the preliminary product remains free of the ceramic-forming layer, wherein the sheet or sheets are formed from the strip and the partially coated sheet or sheets are heat treated.

14. A method according to claim 1, wherein the sheet or sheets are partially coated with a ceramic-forming layer, whereby 20% to 80% of the total surface of the preliminary product remaining free of the ceramic-forming layer and the partially coated sheet or sheets are heat treated.

15. A method according to claim 12,
wherein the heat treatment comprises:
heating up the sheet or sheets, and then
heat treating the sheet or sheets in a first stage for a total time t₁, wherein in the first stage
the preliminary product is heat treated at a temperature within a temperature range of between T_{α+γ/γ} and T₁, and then
cooling the sheet or sheets to room temperature,
wherein the heat treatment is carried out for at least part of the time in a hydrogen-containing atmosphere and during this time the exposed parts of the surface of the sheet or sheets are in direct contact with the hydrogen-containing atmosphere, wherein T₁>T₂, T₁ is above T_{α+γ/γ} is below T_{α/α+γ}.

16. A method according to claim 12,
wherein the heat treatment comprises:
heating up the sheet or sheets, and then
heat treating the sheet or sheets in a first stage for a total time t₁, wherein in the first stage the preliminary product is heat treated at a temperature within a temperature range of between T_{α+γ/γ} and T₁, and then
cooling the sheet or sheets to a temperature T₂, and then
heat treating the sheet or sheets in a second stage at temperature T₂ for a time t₂, and then
cooling the sheet or sheets to room temperature,
wherein the heat treatment is carried out for at least part of the time in a hydrogen-containing atmosphere and during this time the exposed parts of the surface of the sheet or sheets are in direct contact with the hydrogen-containing atmosphere, wherein T₁>T₂, T₁ is above T_{α+γ/γ} and T₂ is below T_{α/α+γ}.

17. A method according to claim 12, wherein T_{α+γ/≢5}>T_{α/α+γ} and the difference T_{α+γ/γ}-T_{α/α+γ}is less than 45K.

18. A method according to claim 12, wherein after the heat treatment the sheet or sheets have an area proportion of a {111}<uvw>texture of no more than 13%, including grains with a tilt of up to +/−10°, when compared to the nominal crystal orientation.

19. A method according to claim 12, wherein after the heat treatment the sheet or sheets have an area proportion of a {100}<uvw>cube-face texture that is at least 30%, including grains with a tilt of up to +/−15°, when compared to the nominal crystal orientation.

20. A method according to claim 12, wherein in order to produce the sheet or sheets the method further comprises the following:
providing by vacuum induction melting, electro-slag remelting or vacuum arc remelting of a melt consisting essentially of:

| | | |
|---|---|---|
| 2 wt % | ≤Co | ≤30 wt %, |
| 0.3 wt % | ≤V | ≤5.0 wt %, |
| 0 wt % | ≤Cr | ≤3.0 wt %, |
| 0 wt % | ≤Si | ≤5.0 wt %, |
| 0 wt % | ≤Mn | ≤5.0 wt %, |
| 0 wt % | ≤Al | ≤3.0 wt %, |
| 0 wt % | ≤Ta | ≤0.5 wt %, |
| 0 wt % | ≤Ni | ≤1.0 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

remainder iron and up to 0.2 wt % of other impurities due to melting,
solidifying the melt to form an ingot,
mechanically deforming the ingot in order to produce a strip, and
forming the sheet or sheets from the strip.

21. A method according to claim 20, wherein the mechanical deformation is carried out by hot rolling and/or forging and/or cold deformation, wherein the ingot is mechanically deformed by means of hot rolling at temperatures of between 900° C. and 1300° C. to form a slab and then to form a hot strip with a thickness D₁, and then being mechanically deformed by cold rolling to form a strip with a thickness D₂, wherein 0.05 mm≤D₂≤1.0 mm and D2 <Di.

22. A method according to claim 21, wherein the hot strip of thickness D₁ is first produced by means of continuous casting, then mechanically deformed by cold rolling to form the strip of thickness D₂, wherein 0.05mm ≤D₂≤1.0 mm, wherein the degree of mechanical deformation by cold rolling is >40%.
